(19) United States
(12) Patent Application Publication
(10) Pub. No.: US 2019/0152630 A1
(43) Pub. Date: May 23, 2019

(54) WORKPIECE BAGGING DEVICE

(71) Applicant: KAWASAKI JUKOGYO KABUSHIKI KAISHA, Kobe-shi, Hyogo (JP)

(72) Inventors: Shuhei KURAOKA, Akashi-shi (JP); Keita SASAKI, Akashi-shi (JP)

(73) Assignee: KAWASAKI JUKOGYO KABUSHIKI KAISHA, Kobe-shi, Hyogo (JP)

(21) Appl. No.: 16/314,769

(22) PCT Filed: Jun. 30, 2017
(86) PCT No.: PCT/JP2017/024216

§ 371 Date: Jan. 2, 2019

(30) Foreign Application Priority Data
Jul. 4, 2016 (JP) 2016-132829

(51) Int. Cl. B65B 5/04; B65B 35/18; B65C 9/08; B65B 43/26

(52) U.S. Cl. CPC B65B 5/04; B65B 43/265; B65C 9/08; B65B 35/18

(57) ABSTRACT

The workpiece bagging device delivers a bag placed on a first placement part to a second placement part and places a workpiece in the bag on the second placement part. The device includes a first arm including, at a tip thereof, at least one first suction part configured to suck the bag, the first arm being configured to move the at least one first suction part, a second arm including, at a tip thereof, a feeding part configured to feed the workpiece, and a second suction part provided on an upper surface of the second placement part. The first suction part sucks the bag placed on the first placement part, delivers the bag to the second placement part, sucks the bag sucked by the second suction part, and moves upward to open the bag, and the workpiece fed by the feeding part is placed in the bag.

### TECHNICAL FIELD

The present disclosure relates to a workpiece bagging device which bags a workpiece.

### BACKGROUND ART

Known as a conventional bagging device is, for example, a device for bagging articles disclosed in Patent Document 1. This device for bagging articles transfers a bag-like container from a first conveyor table to a second conveyor table, where a pair of suction parts suck the bag-like container to open it and an article is placed in the bag-like container.

### REFERENCE DOCUMENT OF CONVENTIONAL ART

### Patent Document

[Patent Document 1] JP2005-075386A

### DESCRIPTION OF THE DISCLOSURE

### Problems to be Solved by the Disclosure

The workpiece bagging device disclosed in Patent Document 1 includes, for example, the first conveyor table, the second conveyor table, and the pair of suction parts in order to perform a series of operations including delivering a bag-like container and opening the bag-like container. Thus, structures intended for the respective operations and structures for transitions from one operation to another operation are needed, which complicates the configuration and control.

The present disclosure is made in view of solving the above problems, and one purpose thereof is to provide a workpiece bagging device capable of easily performing a series of operations for bagging workpiece.

### SUMMARY OF THE DISCLOSURE

In order to achieve the purpose, a workpiece bagging device according to one aspect of the present disclosure delivers a bag placed on a first placement part to a second placement part and places a workpiece in the bag on the second placement part. The workpiece bagging device includes a first arm including, at a tip thereof, at least one first suction part configured to suck the bag, the first arm being configured to move the at least one first suction part, a second arm including, at a tip thereof, a feeding part configured to feed the workpiece, and a second suction part provided on an upper surface of the second placement part. The at least one first suction part sucks the bag placed on the first placement part, delivers the bag to the second placement part, sucks the bag sucked by the second suction part, and moves upward to open the bag, and the workpiece fed by the feeding part is placed in the bag. According to this, a series of operations including delivering and opening the bag is easily performed without changing the positions on the bag at which suction by the first suction part is performed.

The at least one first suction part may include a plurality of first suction parts, and one of the plurality of first suction parts farthest from a mouth of the bag may stop suction, and at least one of the plurality of first suction parts other than the first suction part farthest from the mouth may suck the bag sucked by the second suction part to open the bag. According to this, the mouth of the bag is opened wider than in a case of being opened due to suction by the farthest first suction part.

The at least one first suction part may suck the bag accommodating the workpiece fed by the feeding part and deliver the bag to another place. According to this, the series of operations including delivering and opening the bag is easily performed without changing the positions on the bag at which suction by the first suction part is performed.

The at least one first suction part may suck a label and stick the label to the bag placed on the first placement part. According to this, the series of operations including sticking the label, delivering and opening the bag is easily performed without changing the positions on the bag at which suction by the first suction part is performed.

The label may include a region provided with identification information and another region to be sucked by the at least one first suction part. According to this, an identification information reader reads first identification information while the label is sucked by the first suction part.

The workpiece bagging device may include a robot including the first arm and the second arm and the second suction part. According to this, by using a general-purpose robot of which the tip end is replaceable, the bagging work of the workpiece is possible only by replacing the tip end.

### Effects of the Disclosure

The present disclosure includes the structure described above, and thus produces the effects of easily performing a series of operations for bagging workpieces.

### BRIEF DESCRIPTION OF DRAWINGS

FIG. 1 is a plan view schematically illustrating an overall structure of one example of a robot to which a workpiece bagging device according to an embodiment is applied.

FIG. 2 is a functional block diagram schematically illustrating a structure of a controller of the robot of FIG. 10

FIG. 3 is a perspective view schematically illustrating a state in which a first suction part sucks and delivers a first label.

FIG. 4 is a perspective view schematically illustrating a state in which the first suction part sucks the first label and sticks it to a bag.

FIG. 5 is a perspective view schematically illustrating a state in which the first suction part sucks the bag to open it.

FIG. 6 is a perspective view schematically illustrating a state in which the first suction part sucks the bag and delivers it to an identification information reader.

### MODES FOR CARRYING OUT THE DISCLOSURE

Preferable embodiments will be described below with reference to the accompanying drawings. Note that, in the following, the same or corresponding elements are denoted by the same referential characters throughout the drawings to omit redundant description. The drawings illustrate each element schematically for easier understandings. Directions parallel to an axis of a base shaft are referred to as vertical (up-and-down) directions.

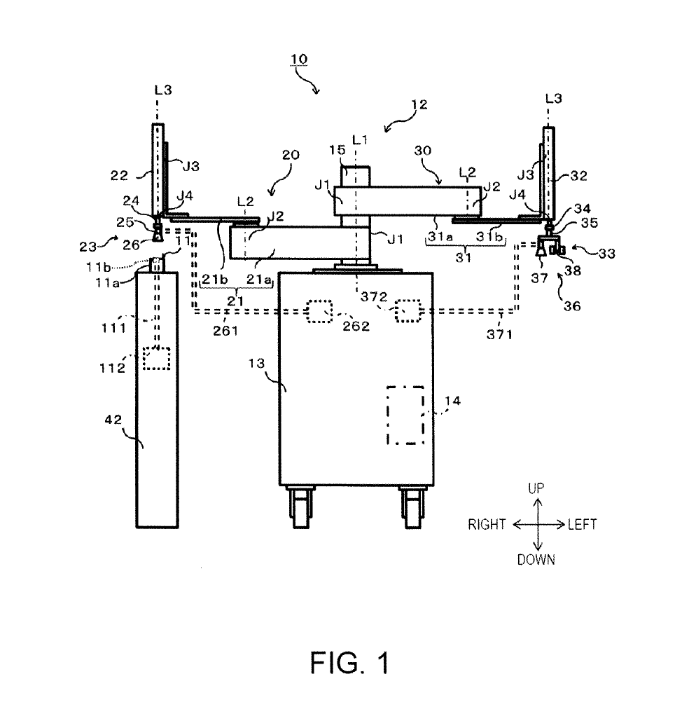

A workpiece bagging device 10 according to this embodiment is a device which delivers a bag 48 placed on a first placement part 46 to a second placement part 11a and places a workpiece 40 in the bag 48 on the second placement part 11a. The following describes the case in which the workpiece bagging device 10 according to the present disclosure includes a robot 12 and a second suction part 11b illustrated in FIG. 1. Note that the workpiece bagging device 10 is not limited to the device including the robot 12. As the robot 12, a horizontal articulated dual-arm robot is described below. Note that other robots such as a horizontal articulated robot and a vertical articulated robot may be employed.

As illustrated in FIG. 1, the robot 12 includes a carriage 13, a pair of robot arms (hereinafter, may simply be referred to as “arms”) 20 and 30 supported by the carriage 13, and a controller 14 accommodated inside the carriage 13. The first arm 20 and the second arm 30 are horizontal articulated robot arms. The first arm 20 includes a first arm part 21, a first wrist part 22, and a first hand part 23. The second arm 30 includes a second arm part 31, a second wrist part 32, and a second hand part 33. Note that the first arm 20 and the second arm 30 may have substantially the same structure except for the first hand part 23 and the second hand part 33. The first arm 20 and the second arm 30 are capable of moving independently of each other and moving in conjunction with each other.

In this example, the first arm part 21 includes a first a-link 21a and a first b-link 21b. In this example, the second arm part 31 includes a second a-link 31a and a second b-link 31b. The first a-link 21a and the second a-link 31a are coupled to a base shaft 15 fixed to an upper surface of the carriage 13 through a rotary joint J1, and are revolvable about a rotation axis L1 passing through the axial center of the base shaft 15. The first b-link 21b is coupled to a tip of the first a-link 21a through a rotary joint J2, and is revolvable about a rotation axis L2 defined at the tip of the first a-link 21a. The second b-link 31b is coupled a tip of the second a-link 31a through a rotary joint J2, and is revolvable about a rotation axis L2 defined at the tip of the second a-link 31a.

The first wrist part 22 is coupled to a tip of the first b-link 21b through a linear-motion joint J3, and is ascendable and descendible with respect to the first b-link 21b. The second wrist part 32 is coupled to a tip of the second b-link 31b through a linear-motion joint J3, and is ascendable and descendible with respect to the second b-link 31b.

The first hand part 23 is coupled to a lower end of the first wrist part 22 through a rotary joint J4, and is revolvable about a rotation axis L3 defined at the lower end of the first wrist part 22. The first hand part 23 includes a first attaching part 24 connected to the first wrist part 22, a first base 25 removably attached to the first attaching part 24, and a first suction part 26 provided to the first base 25. The first attaching part 24, the first base 25, and the first suction part 26 are provided to a tip of the first arm 20, and move in conjunction with the movements of the first arm 20. Details of the first hand part 23 will be described later.

The second hand part 33 is coupled to a lower end of the second wrist part 32 through a rotary joint J4, and is revolvable about a rotation axis L3 defined at the lower end of the second wrist part 32. The second hand part 33 includes a second attaching part 34 attached to the second wrist part 32, a second base 35 removably attached to the second attaching part 34, and a feeding part 36 provided to the second base 35. The second attaching part 34, the second base 35, and the feeding part 36 are provided to a tip of the second arm 30, and move in conjunction with the movement of the second arm 30. For example, the feeding part 36 includes a third suction part 37 and a pair of sandwiching parts 38, and feeds the workpiece 40. Details of the second hand part 33 will be described later.

The first arm 20 and the second arm 30 having the structure described above each have the joints J1 to J4. The first arm 20 and the second arm 30 are each provided with, for example, driving servo motors (not illustrated) corresponding to the joints J1 to J4 and with encoders (not illustrated) which detect rotational angles of the respective servo motors. Moreover, the rotation axis L1 of the first a-link 21a of the first arm 20 and the rotation axis L1 of the second a-link 31a of the second arm 30 are on the same straight line, and the first a-link 21a of the first arm 20 and the second a-link 31a of the second arm 30 are disposed with a height difference therebetween.

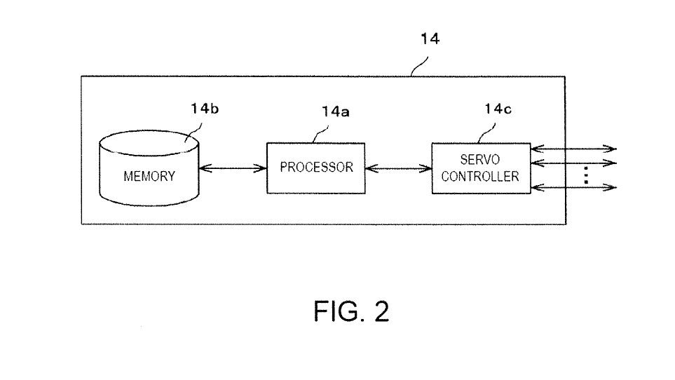

As illustrated in FIG. 2, the controller 14 includes a processor 14a such as a CPU, a memory 14b such as a ROM or a RAM, and a servo controller 14c. The controller 14 is, for example, a robot controller including a computer such as a microcontroller. The controller 14 may include a control device that performs a centralized control or may include a plurality of control devices which collaborate mutually to carry out a distributed control.

The memory 14b stores information, such as a basic program as a robot controller, various fixed data, etc. The processor 14a controls various operations of the robot 12 by reading and executing software, such as the basic program in the memory 14b. That is, the processor 14a generates control commands for the robot 12, and outputs them to the servo controller 14e. The servo controller 14c is configured to control driving of the servo motors corresponding to the joints J1 to J4 of each of the first arm 20 and the second arm 30 based on the control commands generated by the processor 14a.

The following describes the first hand part 23, the second hand part 33, and the second suction part 11b with reference to FIG. 1 and FIGS. 3 to 6. The first hand part 23 includes the first suction part 26 and the second hand part 33 includes the feeding part 36. The feeding part 36 includes the pair of sandwiching parts 38 and the third suction part 37.

As illustrated in FIG. 1, the first base 25 is removably attached to the first wrist part 22 via the first attaching part 24. The second base 35 is removably attached to the second wrist part 32 via the second attaching part 34. The first attaching part 24 and the second attaching part 34 each include a pair of rod-like members. The distance between the pair of rod-like members is adjustable. Thus, the first base 25 is sandwiched by the pair of rod-like members of the attaching part 24, and then the first base 25 is attached to the first wrist part 22. The second base 35 is sandwiched by the pair of rod-like members of the second attaching part 34, and then the second base 35 is attached to the second wrist part 32.

The first suction part 26 is connected with a first vacuum generating device 262 via a first piping 261, the second suction part 11b is connected with a second vacuum generating device 112 via a second piping 111, and the third suction part 37 is connected with a third vacuum generating device 372 via a third piping 371.

The vacuum generating devices 262, 112, and 372, each of which may be a vacuum pump or CONVUM®, generate a negative pressure at the suction parts 26, 11b, and 37, respectively, and are provided to the carriage 13, the first arm 20, the second arm 30, a workbench 42, etc. The pipings 261, 111, and 371 are each provided with, for example, an on-off valve (not illustrated). Opening and closing the pipings 261, 111, add 371 with the on-off valves allow the suction and the stopping of the suction by the suction parts 26, 11b, and 37, respectively. The operation of the vacuum generating devices 262, 112, and 372 and the opening and closing of the on-off valves are controlled by the controller 14. Thus, the vacuum generating devices 262, 112, 372 perform the suction via the suction parts 26, 11b, and 37, respectively, so that a label 41, the bag 48, and the workpiece 40 adhere thereto.

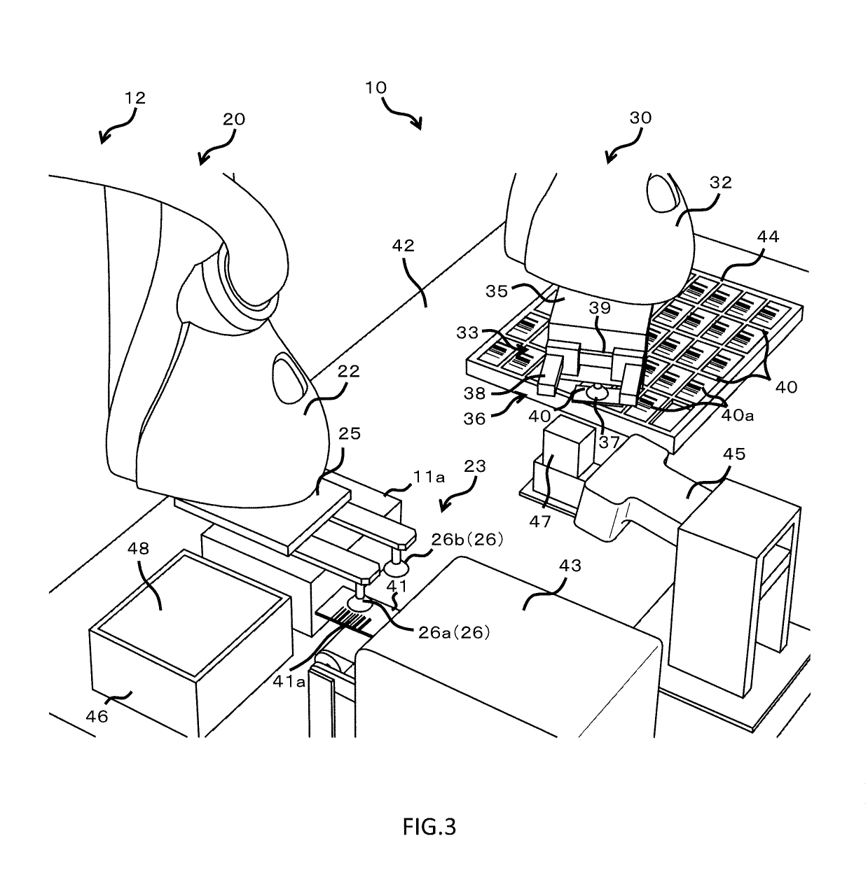

As illustrated in FIGS. 3 to 6, a tip of the first suction part 26 is a suction pad formed from an elastic material such as rubber, and has a shape of a cap which opens downwardly. The first hand part 23 is provided with one or more first suction parts 26 (two in this embodiment). For example, two first suction parts 26 are a first a-suction part 26a and a first b-suction part 26b. The first a-suction part 26a and the first b-suction part 26b are disposed with a space therebetween. The first suction parts 26 revolve about the rotation axis L3 (see FIG. 1) of the first wrist part 22.

The second suction part 11b is provided on, for example, an upper surface of the second placement part 11a. The upper surface of the second placement part 11a, for example, is flat and extends in the horizontal directions. One or more second suction parts 11b (two in this embodiment) open upwardly on the upper surface of the second placement part 11a. The two second suction parts 11b are aligned in the left-and-right directions.

A tip of the third suction part 37 is a suction pad formed from an elastic material such as rubber, and has a shape of a cap which opens downwardly. The third suction part 37 revolves about the rotation axis (see FIG. 1) of the second wrist part 32.

The sandwiching parts 38 provided in a pair are, for example, rod-like members and extend in parallel with each other in the horizontal directions. Proximal ends of the sandwiching parts 38 are connected to an adjustment part 39, and the adjustment part 39 changes the distance between the sandwiching parts 38 provided in a pair.

With reference to FIGS. 3 to 6, the following describes a method for bagging the workpiece 40 through the use of the robot 12 having the structure described above. This method is controlled by the controller 14 (see FIG. 1). Note that, the workpiece 40 is herein a plate-like electronic component but the workpiece 40 is not limited thereto.

As illustrated in FIG. 3, the workbench 42 is placed in front of the robot 12. Placed on the workbench 42 are a label feeder 43, a pallet 44, an identification information reader 45, the first placement part 46, a workpiece placement part 47, and the second suction part 11b.

The label feeder 43 prints identification information (first identification information) 41a on the label 41 and then feeds the label 41, or the label feeder 43 feeds the label 41 provided with the first identification information 41a. The first identification information 41a is provided to an upper surface of the label 41, and an adhesive is attached to a lower surface of the label 41.

The label 41 includes a region provided with the first identification information 41a and another region to be sucked by the first suction part 26 (a region which is to adhere to the first suction part 26 due to suction). Of the regions included in the label 41, a region which is not provided with the first identification information 41a is used as the region to be sucked by the first suction part 26 in this embodiment.

On the pallet 44, a plurality of workpieces 40 are placed. The workpieces 40 are provided with identification information (second identification information) 40a. The workpieces 40 are placed on the pallet 44, with the second identification information 40a on the upside. The identification information reader 45 reads and stores the first identification information 41a and the second identification information 40a with correlation between them. On the first placement part 46, the bag 48 in which no workpiece 40 is packed is placed. The bag 48 is flexible and has a mouth. The workpiece placement part 47 is a table on which the workpiece 40 is to be placed temporarily.

First, the first arm part 21 (see FIG. 1) and the first wrist part 22 of the first arm 20 move the first suction part 26 to the label feeder 43, where the label 41 fed by the label feeder 43 is sucked by the first suction part 26. Of the two first suction parts 26, the first a-suction part 26a sucks the label 41. The first a-suction part 26a adheres to the region of the label 41 different from the region provided with the first identification information 41a, and thus the first identification information 41a is exposed without overlapping the first a-suction part 26a. Then, the first arm 20 moves the first suction part 26 to the first placement part 46.

Moreover, the second arm part 31 (see FIG. 1) and the second wrist part 32 of the second arm 30 move the third suction part 37 to the pallet 44, where the workpiece 40 is sucked and held by the third suction part 37. In this state, the third suction part 37 is delivered to the workpiece placement part 47.

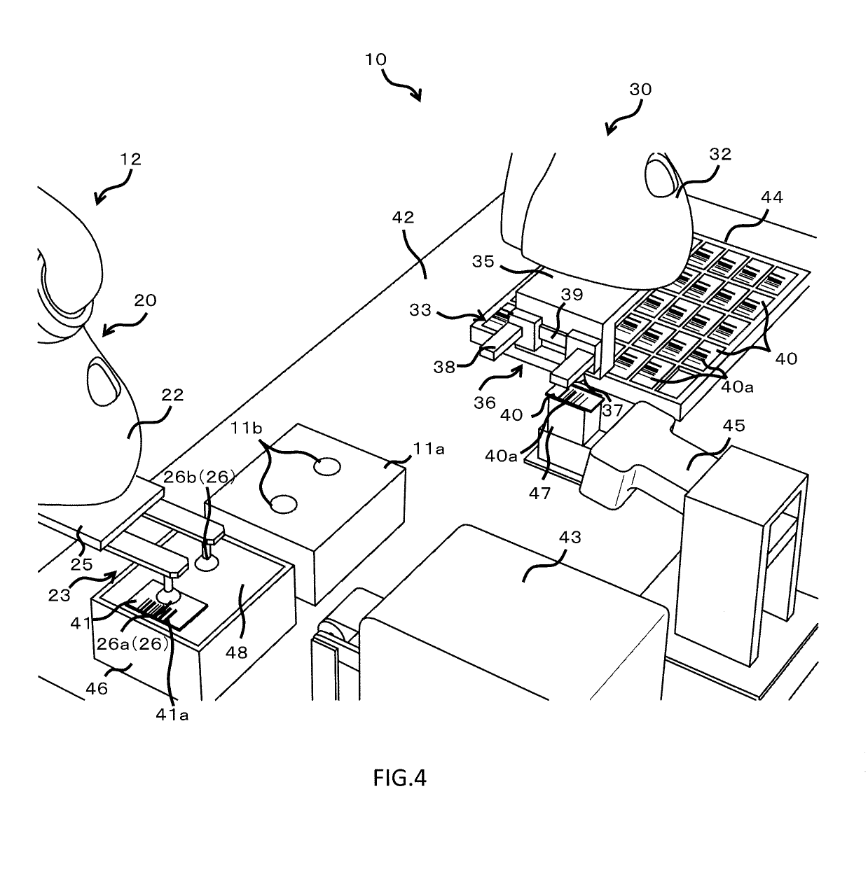

As illustrated in FIG. 4, the label 41 is sucked and delivered to the first placement part 46 by the first a-suction part 26a, and then is placed on an upper surface of the bag 48. The label 41 is stuck to the upper surfaces of the bag 48 through the adhesive on the lower surface of the label 41. Thus, the bag 48 is sucked by the first a-suction part 26a via the label 41. In addition, the bag 48 is sucked by the first b-suction part 26b. In this process, the first a-suction part 26a and the first b-suction part 26b are aligned, for example, in the direction orthogonal to the mouth of the bag 48. The first a-suction part 26a is farther from the mouth of the bag 48 than the first b-suction part 26b is, thus being placed in a position farthest from the mouth of the bag 48.

Then, the workpiece 40 is sucked and delivered to the workpiece placement part 47 by the third suction part 37, and then is placed over the workpiece placement part 47. The suction by the third suction part 37 is stopped, and the workpiece 40 is placed on the workpiece placement part 47.

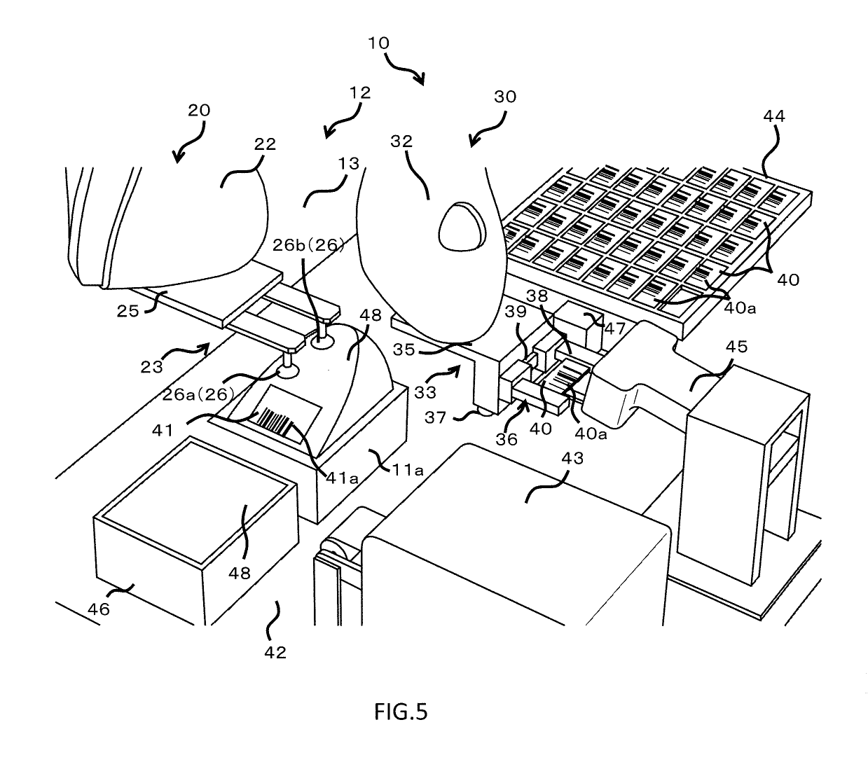

As illustrated in FIG. 5, in the state where the hag 48 is sucked by the first a-suction part 26a and the first b-suction part 26b, the first a-suction part 26a and the first b-suction part 26b are moved to the second suction parts 11b, and then the bag 48 is placed on the second placement part 11a of the second suction parts 11b. Due to suction by the two second suction parts 11b, a lower surface of the bag 48 is sucked by the second suction parts 11b. Of the first suction parts 26, the first a-suction part 26a farthest from the mouth of the bag 48 stops suction, and then the first suction parts 26 are lifted upward. Thus, the first b-suction part 26b closest to the mouth of the bag 48 sucks the upper surface of the bag 48, so that the bag 48 is lifted by the first h-suction part 26b and the mouth of the bag 48 is opened accordingly.

The workpiece 40 placed on the workpiece placement part 47 is sandwiched by the pair of sandwiching parts 38, and the workpiece 40 is delivered to the identification information reader 45. The identification information reader 45 reads and stores the second identification information 40a about the workpiece 40. Subsequently, the sandwiching parts 38 are moved to be placed above the second suction parts 11b, and the sandwiching parts 38 are inserted into the bag 48 on the second suction parts 11b through the mouth of the bag 48. Then, the workpiece 40 is released from the sandwiching parts 38 and is placed in the bag 48.

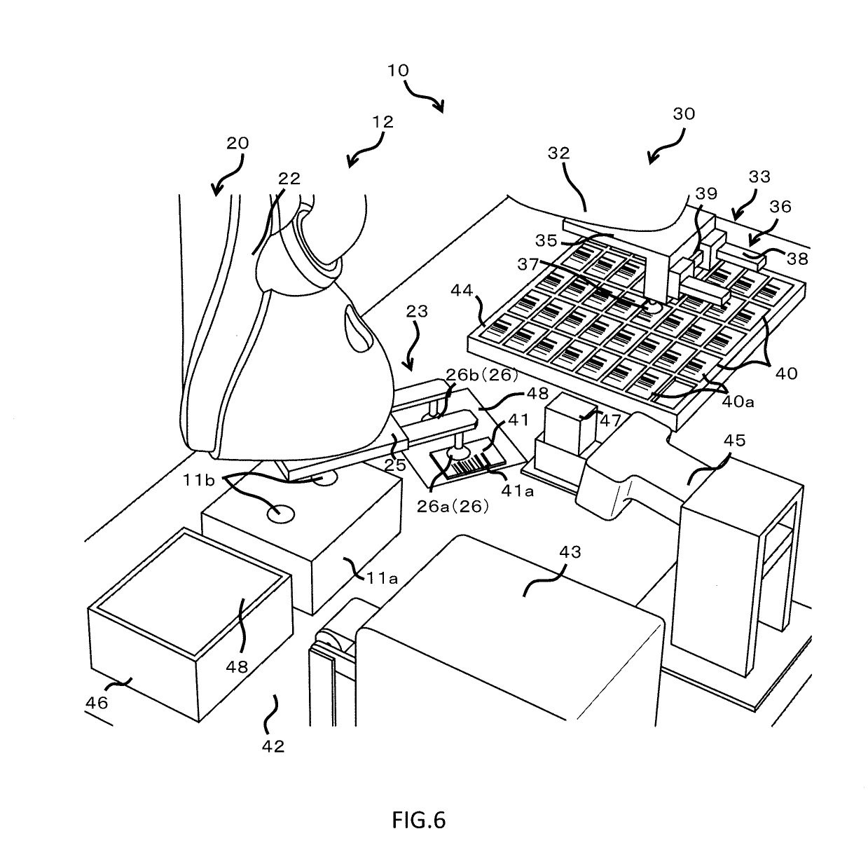

As illustrated in FIG. 6, when the workpiece 40 is placed in the bag 48, the first suction parts 26 are lowered such that the first a-suction part 26a is placed over the bag 48. The first a-suction part 26a returns to the position where it was previously placed prior to the stopping of suction, and is thus located over a region of the label 41 which is not provided with the first identification information 41a. Subsequently, suction by the first a-suction part 26a is resumed, and the bag 48 is sucked by both of the first a-suction part 26a and the first b-suction part 26b. In addition, suction by the second suction parts 11b is stopped. In this state, the first suction parts 26 are moved to the identification information reader 45. The bag 48 is brought to the identification information reader 45 such that the first identification information 41a is within a region where the identification information is readable.

When reading the first identification information 41a, the identification information reader 45 correlates the first identification information 41a with the previously-read second identification information 40a and stores them. Thus, the second identification information 40a about the bag 48 is correlated with the first identification information 41a about the workpiece 40 in the bag 48.

According to this embodiment, the first suction part 26 sucks the bag 48 placed on the first placement part 46, delivers the bag 48 to the second placement part 11a, sucks the bag 48 sucked by the second suction parts 11b, and moves upward to open the bag 48, and then the workpiece 40 fed by the feeding part 36 is placed in the hag 48. Thus, a series of operations including delivering and opening the bag 48 is easily performed owing to suction by the first suction parts 26 and the second suction parts 11b, without changing the positions on the bag 48 at which suction by the first suction parts 26 is performed.

One of the first suction parts 26 sucks the bag 48 sucked by the second suction part 11b to open the bag 48. With the suction by the second suction parts 11b stopped, the first suction parts 26 suck the bag 48 accommodating the workpiece 40 and deliver it to the identification information reader 45. Thus, a series of operations including sticking the label 41, opening the bag 48, and reading the first identification information 41a by the label information reader is easily performed, without changing the positions on the hag 48 at which suction by the first suction parts 26 is performed.

Of the first suction parts 26, the first a-suction part 26a farthest from the mouth of the bag 48 stops suction, and the first b-suction part 26b closest to the mouth of the bag 48 sucks the bag 48 sucked by the second suction parts 11b to open the bag 48. Thus, the mouth of the bag 48 is opened wider than in the case of being opened due to suction by the first a-suction part 26a and the first b-suction part 26b.

The label 41 includes a region provided with the first identification information 41a and another region to be sucked by the first suction part 26. Thus, the first suction part 26 does not overlap the first identification information 41a, and the identification information reader 45 accordingly reads the first identification information 41a while the label 41 is sucked by the first suction part 26.

The workpiece bagging device 10 includes the robot 12 including the first arm 20 and the second arm 30, and the second suction part 11b. Thus, in the workpiece bagging device 10, the first suction part 26 is removably attached to the first wrist part 22 via the first attaching part 24, and the feeding part 36 is removably attached to the second wrist part 32 via the second attaching part 34. The general-purpose robot 12 including the first suction part 26 and the feeding part 36 provided with replaceable tips necessitates only replacement of these tips when bagging the workpieces 40.

The embodiment described above involves operations including sticking the label 41, delivering the bag 48 from the first placement part 46 to the second placement part 11a, opening the bag 48, and delivering the bag 48 from the second placement part 11a to the identification information reader 45. However, it is not always required that all of these operations be performed. In a case where the label 41 does not need to be stuck to the bag, for example, operations including delivering the bag 48 from the first placement part 46 to the second placement part 11a, opening the bag 48, and delivering the bag 48 to the placement part may be performed. Furthermore, in a case where the bag 48 does not need to be delivered to the placement part, operations including delivering the bag 48 from the first placement part 46 to the second placement part 11a and opening the bag 48 may be performed.

With suction by the first a-suction part 26a farthest from the mouth of the bag 48 stopped, the first b-suction part 26b sucks the bag 48 to open it in the embodiment described above. Alternatively, the bag 48 may be opened due to suction by both the first a-suction part 26a and the first b-suction part 26b.

When being opened, the bag 48 is sucked by the first b-suction part 26b closest to the mouth of the bag 48 in the embodiment described above. Note that the first suction parts 26 which perform suction are not limited to the above. In a case where three or more first suction parts 26 are provided, at least one of the first suction parts 26 other than the first b-suction part 26b farthest from the mouth may suck the bag 48.

Although the label 41 is provided with the first identification information 41a in the embodiment described above, it is not always required that the label 41 be provided with the first identification information 41a. If this is the case, the bag 48 accommodating the workpiece 40 is not delivered to the identification information reader 45, and thus does not need to be delivered to, for example, a tray for placement of the bag 48 accommodating the workpiece 40.

In the embodiment described above, the label 41 includes a region provided with the first identification information 41a and another region to be sucked by the first suction part 26. However, it is not always required that the label 41 include the region of the label 41 to be sucked by the first suction part 26 other than the region provided with the first identification information 41a. If this is the case, the first suction part 26 sucks the region of the label 41 provided with the first identification information 41a when the first suction part 26 sucks the label 41. The first suction part 26 overlaps the first identification information 41a. Thus, when the identification information reader 45 reads the first identification information 41a, suction by the first suction part 26 is stopped. The first identification information 41a is exposed accordingly, so that the identification information reader 45 can read the first identification information 41a.

Although the first hand part 23 is coupled with the first wrist part 22 via the first attaching part 24 in this embodiment, the first hand part 23 may he directly coupled to the first wrist part 22. Furthermore, although the second hand part 33 is coupled with the second wrist part 32 via the second attaching part 34, the second hand part 33 may be directly coupled to the second wrist part 32.

Although the feeding part 36 includes the third suction part 37 and the pair of sandwiching parts 38 in the embodiment described above, the feeding part 36 is not limited thereto. For example, the feeding part 36 may include the third suction part 37 or the pair of sandwiching parts 38, or the feeding part 36 may have a structure having another shape.

From the above description, it is apparent for a person skilled in the art that many improvements and other embodiments of the present disclosure are possible. Therefore, the above description is to be interpreted only as illustration, but is provided in order to teach a person skilled in the art the best modes that implement the present disclosure. Details of the structures and/or functions of the present disclosure may substantially be changed without departing from the spirit of the present disclosure.

### INDUSTRIAL AVAILABILITY

The present disclosure is useful for the workpiece bagging device 10, etc. capable of easily performing a series of operations for bagging workpieces.

### DESCRIPTION OF REFERENCE CHARACTERS

10: Workpiece Bagging Device
11b: Second Suction Part
12: Robot
20: First Arm
26: First Suction Part
30: Second Arm
36: Feeding Part
40: Workpiece
41: Label
41a: First Identification Information
45: Identification Information Reader
48: Bag

1. A workpiece bagging device configured to deliver a bag placed on a first placement part to a second placement part and to place a workpiece in the bag on the second placement part, the workpiece bagging device comprising:
a first arm including, at a tip thereof, at least one first suction part configured to suck the bag and the first arm being configured to move the at least one first suction part;
a second arm including, at a tip thereof, a feeding part configured to feed the workpiece; and
a second suction part provided on an upper surface of the second placement part, wherein
the at least one first suction part sucks the bag placed on the first placement part, delivers the bag to the second placement part, sucks the bag sucked by the second suction part, and moves upward to open the bag, and
the workpiece fed by the feeding part is placed in the bag.

2. The workpiece bagging device according to claim 1, wherein the at least one first suction part includes a plurality of first suction parts, and
wherein one of the plurality of first suction parts farthest from a mouth of the bag stops suction, and at least one of the plurality of first suction parts other than the first suction part farthest from the mouth sucks the bag sucked by the second suction part to open the bag.

3. The workpiece bagging device according to claim 1, wherein the at least one first suction part sucks the bag accommodating the workpiece fed by the feeding part and delivers the bag to another place.

4. The workpiece bagging device according to claim 1, wherein the at least one first suction part sucks a label and sticks the label to the bag placed on the first placement part.

5. The workpiece bagging device according to claim 4, wherein the label includes a region provided with identification information and another region to be sucked by the at least one first suction part.

6. The workpiece bagging device according to claim 1, comprising:
a robot including the first arm and the second arm; and
the second suction part.
